(19) United States
(12) Patent Application Publication
(10) Pub. No.: US 2020/0017249 A1
(43) Pub. Date: Jan. 16, 2020

(54) Method and device for producing packages provided with images

(71) Applicant: VITE BEHEER B.V., Voorthuizen (NL)

(72) Inventor: Adrianus Jacobus Tukker, VOORTHUIZEN (NL)

(21) Appl. No.: 16/303,178

(22) PCT Filed: May 22, 2017
(86) PCT No.: PCT/NL2017/000004

§ 371 Date: Nov. 21, 2018

(30) Foreign Application Priority Data
May 24, 2016 (NL) 1041887

(51) Int. Cl. B65B 61/02; B65B 61/26; B31B 50/88; B65D 75/40; B29C 51/18

(52) U.S. Cl. CPC B65B 61/025; B65B 61/26; B29C 51/18; B65D 75/40; B31B 50/88

(57) ABSTRACT

Method for producing packages provided with images, characterized in that successively in a single operating run:—packaging material is supplied;—images are arranged on the supplied packaging material; and—packages are formed from the packaging material provided with images. Also device for producing packages provided with images, characterized in that the device comprises:—supply means suitable for supplying packaging material;—arranging means suitable for arranging images on the supplied packaging material; and—forming means suitable for forming packages from the packaging material provided with images. It is thus possible up to the very last moment, so right up to the moment before forming of packages from a packaging material, to determine the desired images on the final packages. From for instance a single roll of plastic film a number of different types of package can thus be formed for different products with images which can still be freely selected right up to the moment before forming.

The invention relates to a method for producing packages provided with images. The invention also relates to a device for producing packages provided with images. The term ‘image’ is used in its broadest sense in the context of the invention and can designate a word, text, number, figure, drawing and the like, or a random combination thereof.

Practically all packages are provided with images comprising indications such as type of product, number, weight, volume, brand-name, producer, origin, price, date of manufacture, use-by date, list of ingredients, instructions for use, operating instructions and so on. The packaging material from which the packages are later formed can for this purpose be provided with images, for instance by printing, immediately following production thereof. The packaging material provided with images, for instance in the form of a roll of printed plastic film, is then introduced into a packaging machine, after which packages provided with images are formed therefrom. A drawback is that the images are then set and the packaging material, or the roll of plastic film, can only be used for a specific package. Packages can also first be formed from packaging material without images, after which the individual packages are then provided with images. This has the advantage that the images can still be determined after forming of the packages, and per package, although arranging images, or printing on already formed packages, is more time-consuming and more expensive, and requires a more complex device. The present invention now provides an improved solution which does not have the stated drawbacks, or at least does so to lesser extent, and also has a number of advantages of its own.

The invention provides a method according to claim 1 and a device according to claim 10, It is thus possible up to the very last moment, so right up to the moment before forming of packages from a packaging material, to determine the desired images on the final packages. From for instance a single roll of plastic film a number of different types of package can thus be formed for different products with images which can still be freely selected right up to the moment before forming.

The images can be determined here and arranged and positioned on the supplied packaging material such that a formed package is provided with a unique image. Each individual package, or a number of the packages, can thus be provided with a unique image. A unique image can here comprise a date, for instance a date of manufacture, packaging date or use-by date. A unique image can also comprise a number, for instance a serial number. The term ‘number’ is used in its broadest sense in the context of the invention and designates a random combination of numbers, letters and possibly other symbols. The number can also function as lottery number with which a consumer or user can take part in a lottery.

The supplied packaging material can be a plastic film from which packages are formed by means of thermoforming, or a metal, for instance tin or aluminium, sheet material from which cans are formed, or paper or cardboard from which boxes are formed.

The arranging of images preferably comprises digital printing, for instance inkjet printing or electrographic printing. This makes it possible to select the desired images from a digital file and so work quickly and flexibly with images.

It will be apparent that the invention is not limited to the given exemplary embodiments, but that diverse variants self-evident to a skilled person are possible within the context of the invention.

1-14. (canceled)

15. A method for producing packages provided with images, characterized in that successively in a single operating run:
packaging material is supplied, whereby the packaging material is a plastic film;
images are arranged on the supplied packaging material by means of digital printing, for instance inkjet printing or electrographic printing; and
packages are formed from the packaging material provided with images by means of thermoforming.

16. The method of claim 15, characterized in that the images are determined and arranged and positioned on the supplied packaging material such that a formed package is provided with a unique image.

17. The method of claim 16, characterized in that the unique image comprises a date, for instance a date of manufacture, packaging date or use-by date.

18. The method of claim 16, characterized in that the unique image comprises a number, for instance a serial number.

19. The method of claim 17, characterized in that the unique image comprises a number, for instance a serial number.

20. The method of claim 18, characterized in that the unique image comprises a lottery number.

21. The method of claim 19, characterized in that the unique image comprises a lottery number.

22. A device for producing packages provided with images, characterized in that the device comprises:
supply means suitable for supplying packaging material, wherein the supplied packaging material is a plastic film;
arranging means suitable for arranging images on the supplied packaging material by means of digital printing, for instance inkjet printing or electrographic printing; and
forming means suitable for forming packages from the packaging material provided with images by means of thermoforming.
